(19) United States
(12) Patent Application Publication
(10) Pub. No.: US 2005/0265731 A1
(43) Pub. Date: Dec. 1, 2005

(54) Wireless terminal for carrying out visible light short-range communication using camera device

(75) Inventors: Ji-Eun Keum, Suwon-si (KR); Jong-Hwa Lee, Suwon-si (KR); Jae-Yeon Song, Seoul (KR); Hyeon-Woo Lee, Suwon-si (KR); Seung-Kee Yang, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/043,216

(22) Filed: Jan. 26, 2005

(30) Foreign Application Priority Data
May 28, 2004 (KR) 2004-38588
Jul. 20, 2004 (KR) 2004-56593

(51) Int. Cl. H04B 10/04

(52) U.S. Cl. 398/183

(57) ABSTRACT

Disclosed is a wireless communication system using visible light and, more particularly, a short-range wireless communication system using a camera sensor module and a flash module mounted on a wireless terminal. The wireless terminal utilizes an LED and a camera sensor selectively for performing camera functions in a wireless terminal and as interface modules for visible light short-range communication.

### CLAIM OF PRIORITY

This application claims priority to applications both entitled “Wireless Terminal For Carrying Out Visible Light Short-Range Communication Using Camera Device,” filed in the Korean Intellectual Property Office on May 28, 2004 and assigned Ser. No. 2004-38588, and filed on Jul. 20, 2004 and assigned Ser. No. 2004-56593, respectively, the contents of which are hereby incorporated by reference.

### BACKGROUND OF THE INVENTION

1. Field of the Invention

The present invention relates to a wireless communication system and, more particularly, to a short-range wireless communication system having a camera sensor module and a flash module mounted on a wireless terminal.

2. Description of the Related Art

FIG. 1 shows a conventional wireless communication system using (infrared ray) IR for short-range communication. As shown, the system using IR utilizes Peer to Peer (PtoP) communication between wireless terminals 11, 12. Each wireless terminal includes an IR transceiver 101, 102 composed of a transmitter having an LED (Light Emitting Diode) for carrying out the IR transmission, an optical modulator, a receiver having a PD (Photo Diode), and a demodulator, wherein an IR link 13 is formed when both IR transceivers 101, 102 face each other.

FIG. 2 is a schematic diagram showing the conventional wireless terminal system. As shown, the system includes a camera sensor module 26 for sensing optical signals to receive images, a camera driver 25 for operating a camera according to the control of a camera controller 22, an LED module 24, an LED driver 23 connected to the LED module 24 in order to operate the LED module 24 under the control of the camera controller 22, a camera controller 22 for transmitting control signals to the LED driver 23 and the camera driver 25 under the control of a control module 21, and an image signal processor 27 that receives and processes image signals inputted through the camera sensor module 26.

The conventional IR transmission technique has some drawbacks. First, it requires mounting an extra component, an IR transceiver. The IR transmission is accomplished at the speed of several Mbps which lengthens the transmission time. In addition, it is difficult to establish the IR link 13 sometimes since the transmitter and the receiver must face each other. The beam divergence of a transmitter specified by current Standards Organization is 30 degrees. If a beam divergence is away from the specified value, normal communications using IR cannot be accomplished. Further, it is difficult to make the IR link as the infrared ray used in the conventional IR communication systems has a narrow beam divergence, and there is no means for checking whether an IR link is made or not successfully.

Due to the above-described problems, short-range communication systems using visible light have been developed. When visible light is used, it is possible to make a connection link with ease due to a broader transmission angle of a transmitter, and the link establishment can be verified according to the visibility of visible light.

Meanwhile, in the wireless terminal market, the demand for a wireless terminal with camera functions is increasing. Such a terminal typically has a flash module, such as LEDs, mounted for supplementing the camera functions. They have advantages in that they are small in size; they can be easily mounted on wireless terminals; and they need no time to recharge and thus can be conveniently used. In contrast, other conventional flash modules need so-called charge delay time of about 6 seconds for subsequent photographing. Accordingly, it is expected that LEDs will be more increasingly used in a wireless terminal having camera functions in the future.

### SUMMARY OF THE INVENTION

Accordingly, the present invention has been made to meet the above-mentioned requirement and provides additional advantages, by providing a wireless terminal for carrying out visible light short-range communications using a camera device, wherein an LED and a camera sensor are utilized as interface modules for visible light short-range communication.

In one embodiment, there is provided a wireless terminal for carrying out visible light short-range communication using a camera device, which includes a wireless terminal equipped with a camera device including an LED module for supplying light, an LED driver for controlling the action of the LED module, and a camera sensor module for sensing optical signals to transform them into electric signals and for transferring the electric signals. The camera device further comprises: a data processor for processing data to be transmitted through visible light short-range communication and data received through visible light short-range communication; a modulator for modulating the data for transmission which are transferred by the data processor into electric signals that are suitable for a light wireless communication mode and for transferring the electric signals to the LED driver; and a demodulator for demodulating the electric signals into data conformed to the light wireless communication mode and transferring the data to the data processor.

### BRIEF DESCRIPTION OF THE DRAWINGS

The above features and advantages of the present invention will be more apparent from the following detailed description taken in conjunction with the accompanying drawings, in which:

FIG. 1 shows an embodiment of a conventional wireless communication system using IR;

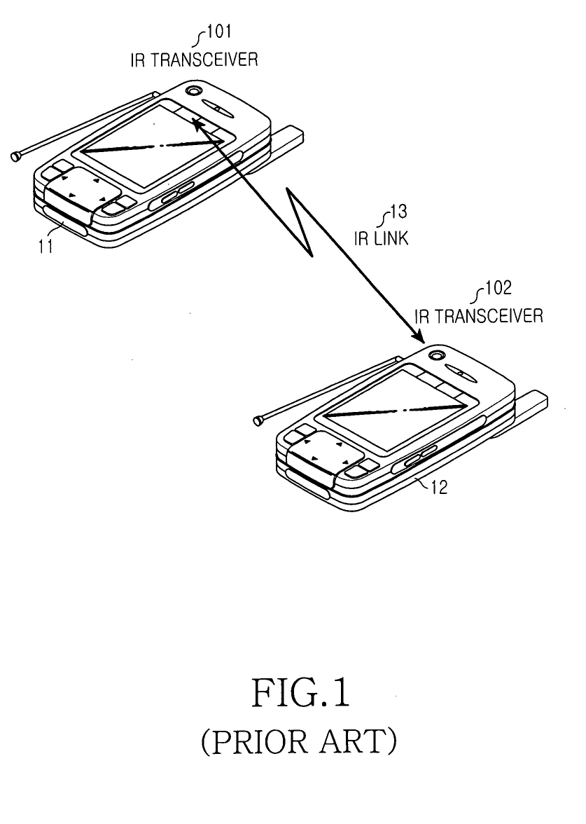

FIG. 2 is a schematic diagram of a conventional wireless terminal;

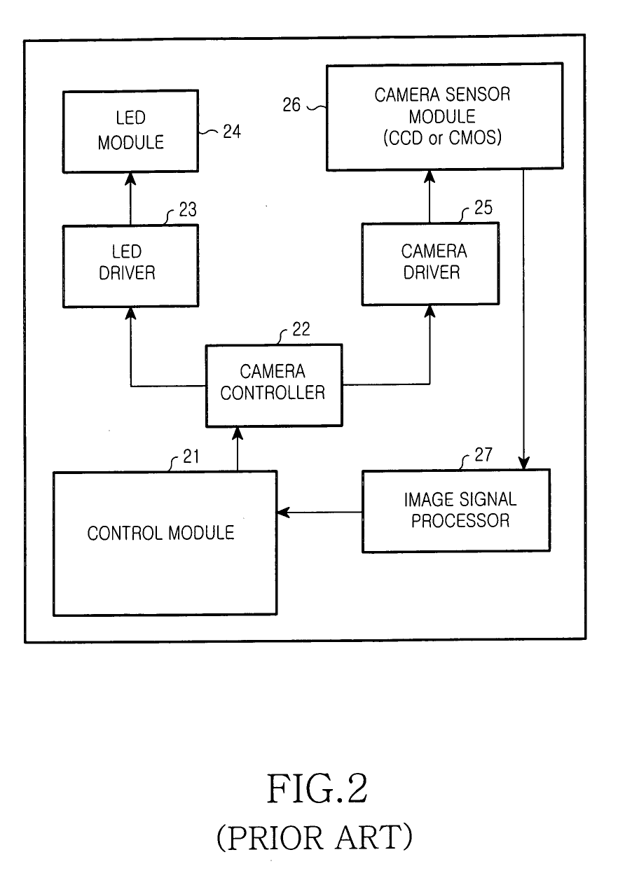

FIGS. 3a and 3b are schematic diagrams showing an embodiment of a transceiver of a visible light short-range communication system according to the present invention;

FIG. 4 is a schematic diagram showing a wireless terminal for carrying out visible light short-range communication using a camera device according to the present invention;

FIG. 5 is an illustrative view of a camera sensor module applied to the present invention;

FIG. 6 is a flow chart showing a method of controlling a wireless terminal when carrying out visible light short-range communication using a camera device according to the present invention;

FIG. 7 is a schematic view showing an embodiment of data transmission/reception between wireless terminals for carrying out visible light short-range communication using a camera device according to the present invention; and

FIG. 8 is a schematic view showing another embodiment of data transmission/reception of a wireless terminal for carrying out visible light short-range communication using a camera device according to the present invention.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

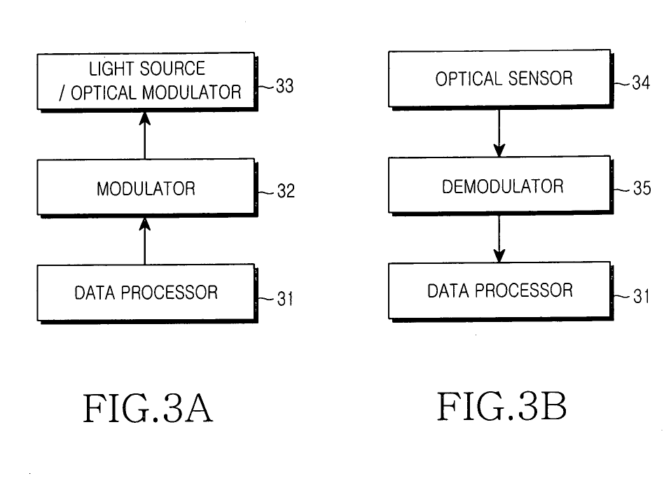

Referring to FIG. 3a, the transmitter of a visible light short-range communication system according to the present invention includes a data processor 31 for processing data, a modulator 32 for modulating the data output from the data processor 31 into signals suitable for light wireless communication, and a light source/optical modulator module 33 for optically modulating the modulated signals so as to transfer them to an external device.

Referring to FIG. 3b, a receiver of a visible light short-range communication system according to the present invention includes an optical sensor 34 for sensing optical signals transferred from the external device and converting them into electric signals, a demodulator 35 for demodulating the electric signals from the optical sensor 34, and a data processor 31 for processing the demodulated data.

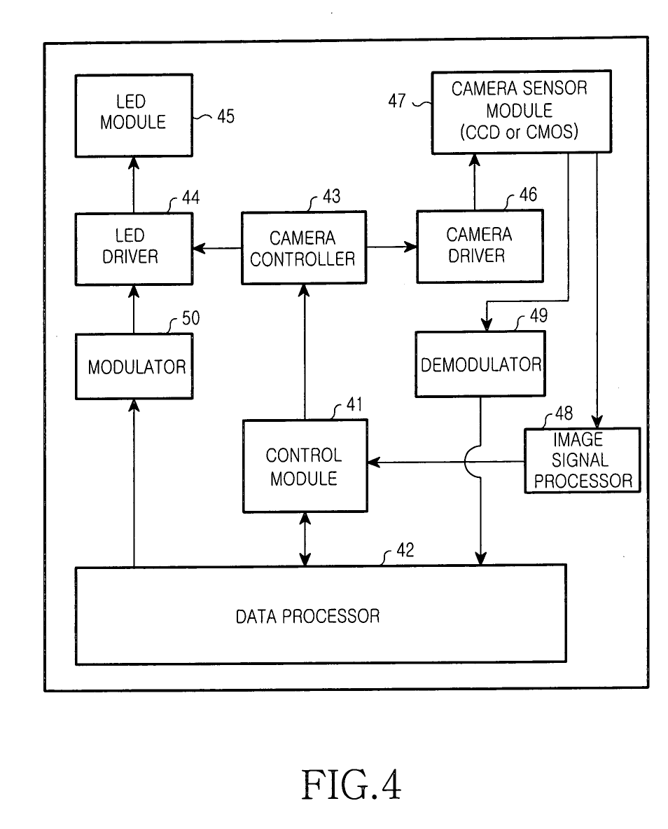

Referring to FIG. 4, a wireless terminal having a camera function to perform visible light short-range communication according to the present invention includes a camera sensor module 47 for sensing optical signals and converting them into electric signals, a camera driver 46 for operating the camera sensor module 47, an LED module 45 for supplying light so as to permit efficient photographing in the dark, an LED driver 44 coupled to the LED module 45, a camera controller 43 for controlling the LED driver 44 and the camera driver 46 so as to cause the camera sensor module 47 and the LED module 45 to operate, an image signal processor 48 for processing image signals using the electric signals from the camera sensor module 47, and a control module 41 for controlling the camera controller 43 to perform the camera functions. The wireless terminal further includes a data processor 42 for processing data for transmission and reception, a modulator 50 for modulating the data from the data processor 42 into signals suitable for light wireless communication, and a demodulator 49 for demodulating the electric signals received from the camera sensor module 47 into data conformed to a light wireless communication mode.

In operation, the LED driver 44 performs camera functions of providing light during a camera mode and performs communication functions during a communication mode. The camera sensor module 47 senses and converts optical signals into electrical signals and transfers the sensed signals to the image signal processor 48 during a camera mode, but sends to the demodulator 49 during a communication mode.

More particularly, it is not necessary to activate all of the PDs (Photo Diodes) corresponding to each pixel included in the camera sensor module 47 when the camera sensor module 47 performs communication functions. Therefore, once the camera driver 46 receives signals representing communication service from the camera controller 43, the camera driver 46 may activate a predetermined number of PDs (Photo Diodes) in the camera sensor module 47 only in order to perform communication functions.

Hereinafter, each functional block illustrated in FIG. 4 will be explained in detail.

First, the modulator 50 modulates the data (RAW data), which are transferred through the data processor 42 into signals suitable for light wireless communication. The LED driver 44 performs optical modulation by turning on/off the LED module 45 according to the modulated signals.

Meanwhile, the camera driver 46 prevents the PDs in the camera sensor module 47 from being entirely activated, thus preventing duplicate data processing through the switching action to one or more specific PDs in the camera sensor module 47. The control signals to such switching action (i.e., control signals related with a selection between the communication mode and the camera mode) are transferred through the camera controller 43 under the control of the control module 41. However, the camera driver 46 may receive such control signals directly from the control module 41.

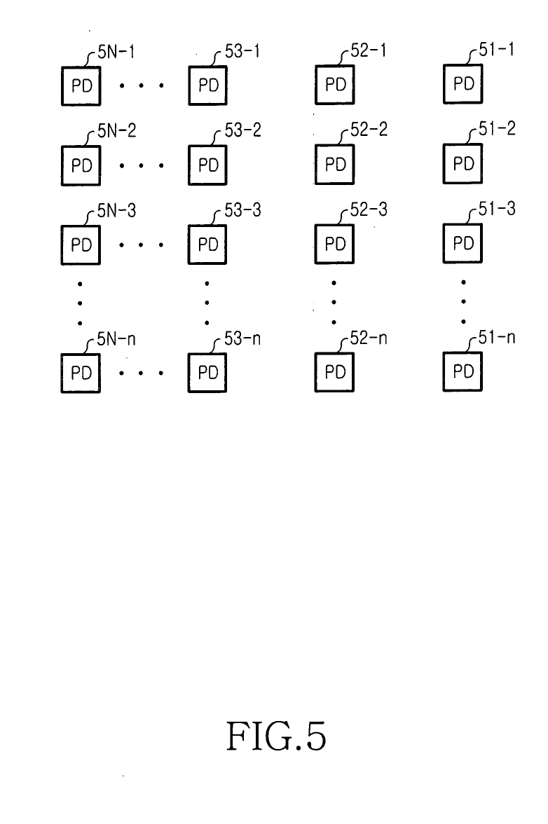

FIG. 5 is an illustrative view of a camera sensor module 47 according to the present invention.

The camera sensor module 47 operates in two modes: CCD (Charge-Coupled Device) mode or the CMOS (Complementary Metal-Oxide Semiconductor) mode. As shown in FIG. 5, the camera sensor module 47 of CCD or CMOS mode has PDs 51-1 to 5N-n corresponding to the number of pixels in the camera device. The PDs in the form of a matrix, as shown in FIG. 5, are simplified so as to represent the characteristics of the optical sensor of the camera sensor module 47 during a CCD or CMOS mode.

In operation, each PD 51-1 to 5N-n transforms the incident light into signal charges (electrons). Thus, the PD 51-1 to 5N-n can act as a receiver when provided in the visible light short-range communication system. Each of the pixels in one camera sensor module 47 of a CCD/CMOS mode divides the transmission wavelength so that each pixel may receive different information. When communication functions are performed, the camera driver 46 causes only a predetermined number of pixels in the camera sensor module 47 to activate in order to receive communication signals. Then, the data inputted through such activated pixels are transferred to the demodulator 49. In contrast, when camera functions are performed, the camera sensor module 47 having PDs 51-1 to 5N-n, which corresponds to the number of pixels of the camera device, is activated to sequentially transfer the electric signals captured by the PDs to the image signal processor 48 according to a predetermined algorithm, thereby presenting images.

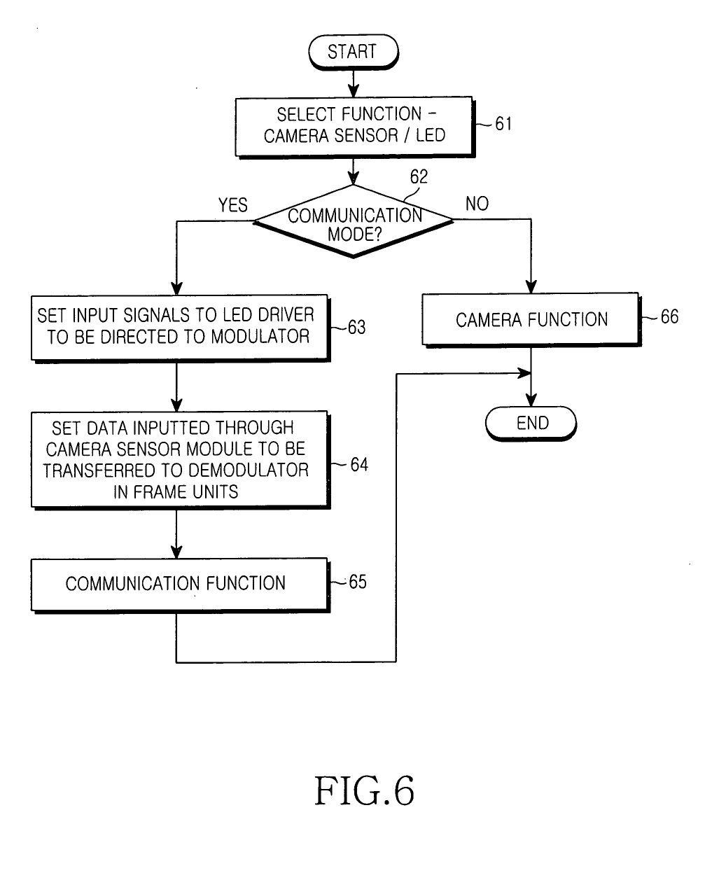

FIG. 6 is a flow chart showing the operation steps of carrying out visible light short-range communication according to the present invention.

As shown in FIG. 6, a selection between the camera sensor module and the LED module is made in the wireless terminal when carrying out visible light short-range communication using a camera device according to the present invention (in step 61).

When the communication mode is selected (in step 62), input signals to the LED driver 44 for operating the LED module 45 of the wireless terminal are set to be directed to the modulator 50 for modulating the data for short-range communication (in step 63). Next, electric signals inputted thorough a predetermined number of PDs activated by the control signals for activating the PDs of the camera sensor module 47 are set to be transferred to the demodulator 49 (in step 64). Accordingly, the visible light short-range communication functions are accomplished through the activated PDs with an external device in step 65.

Meanwhile, when the camera mode is selected (in step 62), the LED module 45 and the camera sensor module 47 of the wireless terminal are set as a conventional input/output device for operating a camera so as to perform camera functions (in step 66).

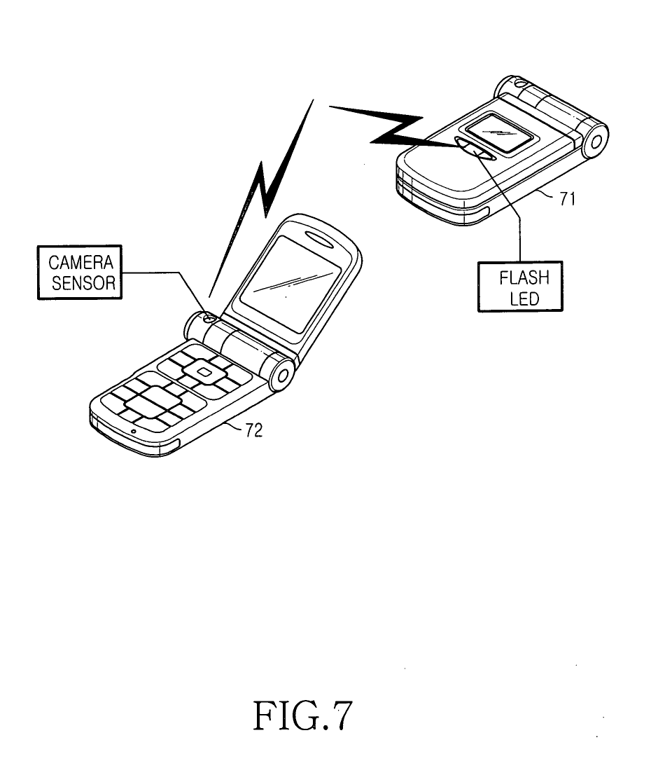

FIG. 7 is a schematic view showing an embodiment of data transmission/reception between wireless terminals for carrying out visible light short-range communication using a camera device according to the present invention. As shown in FIG. 7, data transmission/reception if a wireless terminal is made between two wireless terminals 71, 72, each equipped with a flash LED and a camera sensor.

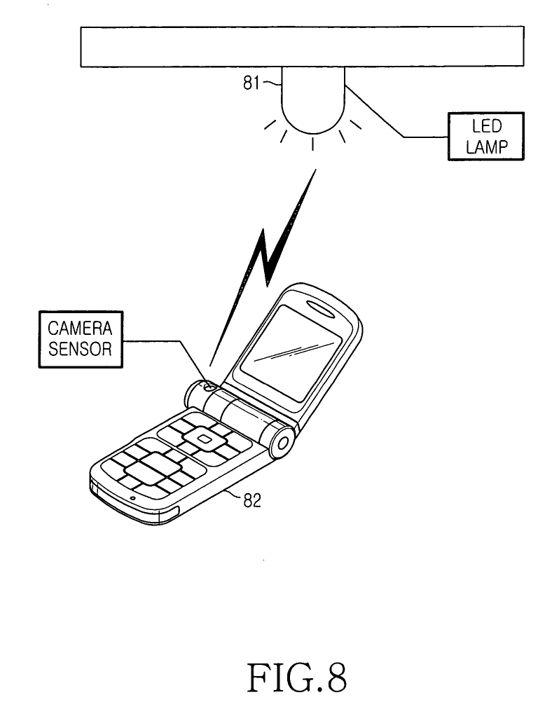

FIG. 8 is a schematic view showing another embodiment of data transmission/reception of a wireless terminal for carrying out visible light short-range communication using a camera device according to the present invention. As shown in FIG. 8, data transmission/reception of a wireless terminal for carrying out visible light short-range communication using a camera device may be made between an AP (Access Point) 81 having an LED lamp and a wireless terminal 82 equipped with a flash LED and a camera sensor. Various types of APs that may be used in data transmission/reception include an advertising panel, an electric lamp, a signboard, etc.

As can be seen from the foregoing, according to the present invention, it is possible to perform visible light short-range communication using widely popularized wireless terminals equipped with camera functions, without the need of additional interface modules. This has an effect of reducing the size of terminals and reducing the fabrication cost.

Further, the system according to the present invention may be realized as a program and stored in a recording medium (CD ROM, RAM, a floppy disc, a hard disc, a magneto-optical disc, etc.) in a form readable by a computer.

While the invention has been shown and described with reference to certain preferred embodiments thereof, it will be understood by those skilled in the art that various changes in form and details may be made therein without departing from the spirit and scope of the invention as defined by the appended claims.

1. A wireless terminal having a camera device for performing visible light communication, comprising:
a camera sensor module having a plurality of photo diodes (PDs);
a Light Emitting Diode (LED) module for modulating signals; and
a controller coupled to the camera sensor and the LED for selectively activating a a predetermined number of the PDs provided in the camera sensor module when performing the visible light short-range communication.

2. The wireless terminal according to 1, wherein the controller activates all the PDs provided in the camera sensor when capturing an image.

3. The wireless terminal according to 1, wherein the camera sensor module is a CCD (Charge-Coupled Device) sensor.

4. The wireless terminal according to claim 1, wherein the camera sensor module is a CMOS (Complementary Metal-Oxide Semiconductor) image sensor.

5. A wireless terminal having a camera device for performing visible light communication, comprising:
an LED (Light Emitting Diode) module;
an LED driver for controlling the LED module;
a camera sensor module having a plurality of photo diodes (PDs) for converting optical signals into electric signals;
a data processor for processing data;
a modulator coupled to the LED driver for modulating the data; and
a demodulator coupled to a processor for demodulating the data, wherein the wireless terminal is controlled selectively to activate a predetermined number of the PDs included in the camera sensor module for visible light short-range communication.

6. The wireless terminal according to claim 5, wherein the LED driver causes the LED module to be operated according to the electric signals transferred from the modulator.

7. The wireless terminal according to claim 5, wherein the camera sensor module senses optical signals through the predetermined number of activated PDs and converts them into electric signals.

8. The wireless terminal according to 5, wherein the camera sensor module is a CCD (Charge-Coupled Device) sensor.

9. The wireless terminal according to claim 5, wherein the camera sensor module is a CMOS (Complementary Metal-Oxide Semiconductor) image sensor.

10. A machine-readable medium having stored thereon data representing sequences of instructions, and the sequences of instructions which, when executed by a processor, cause the processor to:
transmit data using a Light Emitting Diode (LED) module during a communication mode; and
activate a predetermined number of the PDs provided in a camera sensor device during the communication mode.

11. The machine-readable medium according to claim 10, wherein the memory is further configured to allow the processor to capture an image using the camera sensor device by activating all the photo diodes (PDs).
